(19) United States
(12) Patent Application Publication
(10) Pub. No.: US 2014/0278893 A1
(43) Pub. Date: Sep. 18, 2014

(54) REWARD PROGRAM MANAGEMENT SYSTEM AND METHOD

(71) Applicants: Michael T. HOULIHAN, Newbury, MA (US); Robert E. CONTRERAS, Portsmouth, NH (US); Kathryn A. BARNICLE, Addison, TX (US)

(72) Inventors: Michael T. HOULIHAN, Newbury, MA (US); Robert E. CONTRERAS, Portsmouth, NH (US); Kathryn A. BARNICLE, Addison, TX (US)

(73) Assignee: HIGHLANDS OVERRIDE, INC., PORTSMOUTH, NH (US)

(21) Appl. No.: 13/415,559

(22) Filed: Mar. 8, 2012

Related U.S. Application Data
(63) Continuation of application No. 13/188,203, filed on Jul. 21, 2011, now abandoned.
Application No. 13/188,203 is a continuation of application No. 12/961,067, filed on Dec. 6, 2010, now abandoned.
Application No. 12/961,067 is a continuation of application No. 12/765,833, filed on Apr. 22, 2010, now abandoned.
(60) Provisional application No. 61/171,726, filed on Apr. 22, 2009.
(60) Provisional application No. 61/171,722, filed on Apr. 22, 2009.
(60) Provisional application No. 61/171,732, filed on Apr. 22, 2009.
(60) Provisional application No. 61/171,737, filed on Apr. 22, 2009.

(51) Int. Cl. G06Q 30/02; G06Q 50/06

(52) U.S. Cl. CPC G06Q 30/0227; G06Q 50/06
USPC 705/14.28

(57) ABSTRACT

Reward program management system for managing multiple rewards earned through participation in multiple reward earning programs of different earn partners by a person, the person having multiple identifiers, comprising: a server accessible to earn partners receiving reward information including rewards earned by the person and one of the multiple identifiers; a database storing the rewards earned by the person and the identifier associated with each reward; the server providing the person with an interface to receive information from the person regarding at least two of the multiple identifiers to create a set of linked identifiers; a computer processor retrieving and totaling the rewards earned by the person stored in the database in association with all of the identifiers of the set of linked identifiers to create a total reward; the server, accessible to burn partners, providing information regarding the total reward upon receipt from a burn partner of one of the set of linked identifiers.

### CROSS-REFERENCE TO RELATED APPLICATIONS

The present patent application is a continuation of U.S. patent application Ser. No. 13/188,203, entitled “Reward Program Management System and Method”, filed Jul. 21, 2011. Through the '203 application, the present application claims the benefit of priority to U.S. patent application Ser. No. 12/961,067, entitled “Reward Program Management System and Method”, filed Dec. 6, 2010. Through the '067 application, the present application claims the benefit of priority to U.S. patent application Ser. No. 12/765,833, entitled “Reward Program Management System and Method”, filed Apr. 22, 2009. Through the '833 application, the present application also claims the benefit of priority to U.S. Provisional Patent Application Ser. No. 61/171,726, entitled “Rewards Program Maintenance Systems and Methods Including Linking Feature”, filed Apr. 22, 2009. The present application is also related to the following United States Provisional Patent Applications: (1) Ser. No. 61/171,722, entitled “Fuel Dispenser Adapter for a Rewards Program Interface”, filed Apr. 22, 2009; (2) Ser. No. 61/171,732, entitled “Rewards Program Maintenance Systems and Methods Including Employee Program”; and (3) Ser. No. 61/171,737, entitled “Rewards Program Maintenance Systems and Methods”, filed Apr. 22, 2009. All of the above-mentioned Provisional Applications are incorporated by reference herein in their entirety.

### FIELD OF THE INVENTION

This disclosure generally relates to rewards programs providing automatic discounts at point of sales locations. More specifically, methods and systems are disclosed for use in implementing and maintaining rewards programs capable of involving multiple parties (“Earn Partners”) from which a Program Member can earn discounts; multiple parties (“Bum Partners”) from which a Program Member can redeem earned discounts, and an accounting system in which a Program Member's account can be maintained by a Program Manager and accessed by the Earn and Burn Partners and the respective Program Member.

### BACKGROUND OF THE INVENTION

Rewards programs are becoming increasingly popular in commerce today. A rewards program is usually implemented by a vendor to encourage sales of its products and/or services. To attract business, maintain a client base, or otherwise incentivize consumer purchases, a vendor can award benefits to customers based on certain purchasing criteria. For example, a customer may earn $5 in rewards for every $100 spent with the vendor. Other criteria for awarding benefits include earning awards for purchases made on a certain date or purchases of specific products and/or brands.

One program that has been described includes the awarding of fuel discounts to customers of a particular vendor based upon non-fuel products purchased from the vendor. For example, a vendor may be in the form of a convenience store selling fuel, food and drinks. Customers may be given a discount on the price per gallon/liter based on certain purchases of non-fuel products in the convenience store.

### SUMMARY OF THE DISCLOSURE

In accordance with one aspect a reward program management system for managing a combination of a plurality of rewards earned by a person through participation in a plurality of reward earning programs of different earn partners is disclosed. The person has a plurality of identifiers associated with that person, at least some of which being in respect of the plurality of reward earning programs. The system comprises:

at least one server accessible to earn partners via electronic communication over at least one network, the at least one server configured to receive reward information from earn partners, the reward information including, in respect of the person, at least a reward earned by the person and one of the plurality of identifiers associated with the person associated with the reward;

at least one computer-readable information storage medium in electronic communication with the at least one server, the at least one computer-readable information storage medium including at least one database storing at least a plurality of the rewards earned by the person and the identifier associated with each reward;

the at least one server accessible to the person via the at least one network and in electronic communication with the at least one computer-readable information storage medium, the at least one server configured to provide the person with an interface to receive information from the person regarding at least two of the plurality of identifiers associated with the person to create a set of linked identifiers associated with the person;

a computer processor in electronic communication with the at least one computer-readable information storage medium, for retrieving and totaling the rewards earned by the person stored in the at least one database in association with all of the identifiers of the set of linked identifiers, to create a total reward associated with the person, the at least one database storing at least the total reward associated with the person and at least one of the set of linked identifiers; and

the at least one server accessible to burn partners via the at least one network and in electronic communication with at least one computer-readable information storage medium, the at least one server configured to provide information regarding the total reward associated with the person upon receipt from a burn partner of the at least one of the set of linked identifiers.

In accordance with another aspect a reward program management system is disclosed for managing a combination of a plurality of rewards earned by a person through participation in a plurality of reward earning programs of different earn partners. The person has a plurality of identifiers associated with that person, at least some of which being in respect of the plurality of reward earning programs. The system comprises:

a first server accessible to earn partners via electronic communication over a first network, the first server configured to receive reward information from earn partners, the reward information including, in respect of the person, at least a reward earned by the person and one of the plurality of identifiers associated with the person associated with the reward;

a first computer-readable information storage medium in electronic communication with the first server, the first computer-readable information storage medium including a first database storing at least a plurality of the rewards earned by the person and the identifier associated with each reward;

a second server accessible to the person via a second network and in electronic communication with the first computer-readable information storage medium, the first server configured to provide the person with an interface to receive information from the person regarding at least two of the plurality of identifiers associated with the person to create a set of linked identifiers associated with the person;

a computer processor in electronic communication with the first computer-readable information storage medium, for retrieving and totaling the rewards earned by the person stored in the first database in association with all of the identifiers of the set of linked identifiers, to create a total reward associated with the person;

a second computer-readable information storage medium in electronic communication with the computer processor, the second computer-readable information storage medium including a second database storing at least the total reward associated with the person and at least one of the set of linked identifiers; and

a third server accessible to burn partners via a third network and in electronic communication with the second computer-readable information storage medium, the third server configured to provide information regarding the total reward associated with the person upon receipt from a burn partner of the at least one of the set of linked identifiers.

In accordance with another aspect a method is disclosed of managing a plurality of reward earning programs in order to provide for joint burning of rewards earned through different ones of the plurality of reward earning programs. The method comprises:

receiving, via at least one network, a first electronic signal representative of information including at least (i) a first reward earned by the person at a first earn partner through a first reward earning program, and (ii) a first identifier associated with the person in respect of the first reward;

storing the information received via the first electronic signal in at least one computer-readable information storage medium;

receiving, via the at least one network, a second electronic signal representative of information including at least (ii) a second reward earned by the person at a second earn partner through a second earning program, and (ii) a second identifier associated with the person in respect of the second reward;

storing the information received via the second electronic signal in the at least one computer-readable information storage medium;

sending, via the at least one network, a third electronic signal representative of an interface allowing the person input at least the first identifier and the second identifier;

receiving, via the at least one network, a fourth electronic signal representative of at least the first identifier and the second identifier generated in response to input from the person;

creating a link, via at least one computer processor, between at least the first identifier and the second identifier to create a set of linked identifiers associated with the person;

totaling, via the at least one computer processor, the rewards earned by the person stored in association with all the identifiers of the set of linked identifiers to create a total reward associated with the person;

receiving, via the at least one network, a fifth electronic signal representative of the at least one of the set of linked identifiers associated with the person;

sending, via the at least one network, a sixth electronic signal representative of the total reward associated with the person.

In accordance with another aspect a method is disclosed of managing a plurality of reward earning programs in order to provide for joint burning of rewards earned through different ones of the plurality of reward earning programs. The method comprises:

receiving, via a first network, a first electronic signal representative of information including at least (i) a first reward earned by the person at a first earn partner through a first reward earning program, and (ii) a first identifier associated with the person in respect of the first reward;

storing the information received via the first electronic signal in a first computer-readable information storage medium;

receiving, via the first network, a second electronic signal representative of information including at least (ii) a second reward earned by the person at a second earn partner through a second earning program, and (ii) a second identifier associated with the person in respect of the second reward;

storing the information received via the second electronic signal in the first computer-readable information storage medium;

sending, via a second network, a third electronic signal representative of an interface allowing the person input at least the first identifier and the second identifier;

receiving, via the second network, a fourth electronic signal representative of at least the first identifier and the second identifier generated in response to input from the person;

creating a link, via a first computer processor, between at least the first identifier and the second identifier to create a set of linked identifiers associated with the person;

totaling, via a second computer processor, the rewards earned by the person stored in association with all the identifiers of the set of linked identifiers to create a total reward associated with the person;

receiving, via a third network, a fifth electronic signal representative of the at least one of the set of linked identifiers associated with the person;

sending, via the third network, a sixth electronic signal representative of the total reward associated with the person.

In accordance with yet another aspect a method is disclosed of managing a plurality of reward earning programs in order to provide for joint burning of rewards earned through different ones of the plurality of reward earning programs. The method comprises:

receiving, via a first network, a first electronic signal representative of information including at least (i) a first reward earned by the person at a first earn partner through a first reward earning program, and (ii) a first identifier associated with the person in respect of the first reward;

storing the information received via the first electronic signal in a first computer-readable information storage medium;

receiving, via the first network, a second electronic signal representative of information including at least (ii) a second reward earned by the person at a second earn partner through a second earning program, and (ii) a second identifier associated with the person in respect of the second reward;

storing the information received via the second electronic signal in the first computer-readable information storage medium;

sending, via a second network, a third electronic signal representative of an interface allowing the person input at least the first identifier, the second identifier, and a master identifier;

receiving, via the second network, a fourth electronic signal representative of at least the first identifier, the second identifier, and the master identifier generated in response to input from the person;

creating a link, via a first computer processor, between at least the first identifier, the second identifier, and the master identifier to create a set of linked identifiers associated with the person;

totaling, via a second computer processor, the rewards earned by the person stored in association with all the identifiers of the set of linked identifiers to create a total reward associated with the person;

receiving, via a third network, a fifth electronic signal representative of the master identifier associated with the person;

sending, via the third network, a sixth electronic signal representative of the total reward associated with the person.

In accordance with still another aspect a reward program management system is disclosed. The system comprises:

a plurality of rewards earned by a person through participation in a plurality of reward earning programs of different earn partners, the person having a plurality of identifiers associated with the person in respect of the plurality of reward earning programs, each of the rewards having at least one of the plurality of identifiers associated therewith, at least two of the rewards having different ones of the plurality of identifiers associated therewith;

a master identifier associated with the person; and an interface allowing the person to link the plurality of identifiers with the master identifier so as to permit joint burning of the plurality of rewards.

In accordance with yet another aspect a method is disclosed of managing a plurality of reward earning programs in order to provide for joint burning of rewards earned through different ones of the plurality of reward earning programs. The method comprises:

receiving first reward information including at least (i) a first reward earned by the person at a first earn partner through a first reward earning program, and (ii) a first identifier associated with the person in respect of the first reward;

receiving second reward information including at least (ii) a second reward earned by the person at a second earn partner through a second earning program, and (ii) a second identifier associated with the person in respect of the second reward;

linking the first identifier and the second identifier to create a set of linked identifiers associated with the person;

totaling the rewards earned by the person stored in association with all the identifiers of the set of linked identifiers to create a total reward associated with the person;

sending the total reward associated with the person for burning.

In accordance with still another aspect a software interface is disclosed for permitting a person to maintain one or more reward program memberships. The interface is configured to provide displays including:

a prompt requesting identification information;

a list of earn partner rewards programs in which a person participates;

information on earned rewards for each earn partner on the list; and

an option to link two or more of the earn partner rewards programs on the list to jointly burn rewards earned in linked earn partner rewards programs.

Finally, in accordance with yet another aspect a website is disclosed that includes one or more storage media for storing instructions and data for carrying out various steps associated with one or more rewards programs. The one or more storage media includes:

creating one or more member accounts associated with one or more rewards programs, respectively, of which a person is a member;

linking two or more existing member accounts;

accessing the customer accounts using one form of identification; and

accounting for earned rewards accrued from rewards earned in the two or more rewards programs and burned rewards burned by the person.

### BRIEF DESCRIPTION OF THE DRAWINGS

The following is a brief description of the drawings.

FIG. 1 is an embodiment of a rewards program structure.

FIG. 2 shows one embodiment of member accounts before and after linking them.

FIG. 3 shows a member database entry and an on-line database entry in accordance with one embodiment of the present disclosure.

FIG. 4 shows a typical sequence of a transaction involving the redemption of rewards.

### DETAILED DESCRIPTION OF THE INVENTION

Reward programs implemented by a vendor provide several benefits to the vendor, including incentivizing its customers to buy certain products resulting in an increase in sales. By providing reward discounts, for example, on fuel based on the purchase of non-fuel products, the vendor can encourage the purchase of both. However, such programs have their limits because the vendors are limited to their own customers, products and/or services bases. The present disclosure describes methods of and systems for implementing reward programs established by multiple parties defined as “Earn Partners”, and allowing redemption of rewards under the various reward programs with multiple parties defined as “Burn Partners” (which may or may not include one or more of the Earn Partners). Each member of each reward program, hereinafter a “Program Member,” thus has more freedom to make a broader selection of purchases from multiple Earn Parties and the convenience of being able to redeem rewards from anyone of a plurality of Burn Partners. A further advantage is that each Earn Partner determines what conditions are required for each of its Program Members to earn rewards, and the amount of the reward. Thus, each Earn Partner can provide its own rewards program in which one or more criteria is used to determine what products and/or services qualify for earned rewards, and thus has complete control of those programs and the relative value of those goods and services that qualify for rewards. In this regard the Earn Partners' programs can be completely disparate from one another, with the only thing in common being the rewards given to the Program Members, which can be redeemed from anyone of the Burn Partners. In the example described, this common redemption based reward is a discount on fuel provided by Burn Partners, although it should be appreciated that the common redemption based reward can be any type of goods or services.

In the embodiments described, the rewards are provided by each of the Earn Partners in the form of a discount on the unit price of fuel sold at participating fueling stations operated by each of the Burn Partners. In this regard, the redemption feature presents a common redemption value for all of the rewards programs offered by the Earn Partners, with each Earn Partner having the complete discretion of establishing the relative value of the incentives provided to its customers to earn rewards, and the relative value of those rewards.

In one embodiment the system includes a database and website services operated by a Program Administrator in support of multiple Earn Partner rewards programs that mainly seeks to leverage consumer-spending habits to create an increase in fuel consumption for retail fueling stations, preferably including those operated by one or more retail fueling station operators, each of which being a Burn Partner. In principal, the system preferably offers discounts off the price per gallon, or equivalent discounts off the per unit (liter or gallon) price of fuel, preferably at the point of sale, as incentive rewards for qualified purchases at approved retail partner locations operated by one or more Earn Partners, although this is not the sole means by which awards can be earned. For example, awards can be given by an Earn Partner to its employees as an employee benefit. Awards can also be given as an incentive to buy particular products including automobiles from select dealerships. There is no limit as to how the awards might be earned. Thus, by way of example, an Earn Partner that operates a grocery store might offer a reward of a $0.10 per gallon/liter discount on a purchase of fuel up to 20 gallons (at any of the fueling stations operated by the Burn Partners) for every $100.00 of goods purchased at one of its stores. Another Earn Partner might offer $0.05 per gallon/liter discount on a purchase of an unlimited number of gallons of fuel with one fill-up (at any of the fueling stations operated by a Burn Partner) for the purchase of a specific brand product. A car dealership might offer to purchasers of one of its cars a $0.35 gallon/liter discount on every fill up for a year. And yet another Earn Partner may simply want to provide its employees with the benefit of a discount of $0.20 per gallonliter on the purchase of up to 30 gallons of fuel per month, simply as an employee benefit. It should be appreciated that an entity can be both an Earn and Burn Partner.

FIG. 1 shows one embodiment of a system architecture of a system for maintaining a database and website services in support of partners based rewards programs. This architecture includes Earn Partners 100, Burn Partners 108, servers 104 and connectivity to monitor and update earning and burning of rewards. For example, an Earn Partner can operate its store with a at least one point-of-sale terminal 112 in the store and at least one loyalty server 116, located on-site, remotely, or otherwise, for tracking purchases by the store's customers, including those participating in its rewards program. The point-of-sale terminal 112 can register purchases a customer makes, and this purchasing information can be reported to the purchaser's account in the store's corresponding loyalty server 116. The loyalty server 116 can update the purchaser's account with respect to earned rewards. Similarly, employee benefits can be reported to and updated on a corresponding employee reward server 120. Thus, each Earn Partner will determine what rewards each Program Member has earned in accordance the Earn Partner's own criteria. Once the earned rewards are determined and stored in an appropriate database in one or more servers (such as servers 116 and 120), data for each Program Member can be transferred to one or more databases maintained by a program administrator, hereinafter referred to as the “Program Administrator”. Preferably, the Earn Partners each deliver data associated with each of their reward programs member databases from reward servers 116, 120 over a network, which can be the Internet, to database servers 124. This delivery can occur instantaneously or at intervals. The data transferred for each reward transaction given to a Program Member includes data identifying: (a) the Earned Partner, (b) the Program Member, and (c) the amount of rewards earned for that transaction. The data transferred for each rewards transaction can also include any restrictions on each reward, such as an expiration date by which the reward needs to be redeemed.

While FIG. 1 suggests that the Earn Partners are retailers, it should be evident that the Earn Partners can be any type of business or entity. The Earn Partner can be in any type of business selling goods or services, whether retail, wholesale or otherwise. For example, the Earn Partner can be a grocery store, coffee shop, donut shop, art store, hardware store, etc. The Earn Partner can also be a service organization, such as a car wash, laundry, restaurant, etc. Other examples include a car dealership or group of dealerships, and a car rental company providing fuel discounts to each customer who buys, leases or rents a vehicle.

Although only three Earn Partner locations and two Burn Partner locations are shown in FIG. 1, the number of locations of each can clearly vary from one single location to as many as desired for each type of Partner. Further, each Earn Partner store A, B and C is shown in FIG. 1 as including one point of sale terminal and one loyalty server, it should be evident that each store can include more than one of each.

The central servers and connectivity 104 maintained by the Program Administrator can include at least one database server 124 and at least one interface server 128. The database server 124 receives the data from each Earned Partner 100 regarding rewards earned by each individual Program Member from each Earned Partner's reward program. These server 124 also receive burn requests from Burn Partners 108, when the Program Member of the program redeems rewards credited to him or her, as described in greater detail hereafter. The architecture of this embodiment further allows each Program Member to remotely monitor and configure their rewards program member accounts from their own access devices, such as computer 132. The access device is not limited to computers, but can include personal digital assistants, smart phones, etc. This monitoring and configuring can occur through at least one interface server 128. It could also occur through telephonic conversations with customer service representatives. Finally, all accounting and settlement with the Earn and Burned Partners can be accomplished by the Program Administrator. Again, the number of locations of the Program Administrator, database servers and interface servers can clearly vary. Further, any technique can be used to identify the Program Member. In addition to personal cards, one could use any personal identification information including biometrics, such as fingerprints or facial images, and special transponders, for example wireless devices, provided to the Program Member.

As mentioned, the embodiment of FIG. 1 also includes Burn Partners 108 where Program Members can redeem (or burn) their earned rewards. In the illustrated embodiment, the earned rewards are burned at fueling stations through fuel discounts. For example, purchases at a grocery store owned by Company A may award a consumer a $0.10 per gallon/liter discount on fuel at a fueling station owned by anyone of several gas and oil companies. Each fueling station can include a point-of-sale terminal 136 as well as a card reader in dispenser (CRIND) 140, both of which can be configured to receive not only bank cards, but also identification cards from a Program Member. These identification cards can be issued by the Program Manager, and thus can be used to reference all of the Reward Programs to which the Program Member receives benefits. The identification cards can also be the cards issued by each Earn Partner in association with its own Reward Program. By receiving Program Member identification information, account information associated with the identified Program Member can be identified from database servers 124 and any available fuel discount entitlements can be processed for the benefit of the Program Member. As will be more evident hereinafter, in accordance with one embodiment when the Program Administrator uses the identification card issued by the Program Administrator, all available discount rewards will be available to the Program Member regardless of which Reward Programs or its sponsoring Earn Partner originated the reward. All of the rewards will be linked and added together to provide maximum reward redemption to the Program Member when he/she registers at the pump. In the default condition, each identification card associated with one Rewards Program will provide for redemption only those rewards earned through that Rewards Program. However, the Program Member can access his/her account on line and link the Rewards Programs to which he or she is a member. Any identification card associated with a linked Rewards Program will result in the Earned rewards accumulated through the linked Rewards Programs being available for redemption so that any identification card associated with one of the linked Rewards Programs can be used to redeem rewards of all of the linked Rewards Programs.

Again, the number of Burn Partners locations can clearly vary, with only two being shown in FIG. 1 by way of example. Further, the number of point of sale terminals database and interface servers can vary.

Each fueling station of a Burn Partner includes at least one fuel dispensing pump 144 for dispensing fuel and a fuel controller 148 to activate the gas pump and regulate the price of gas per gallon/liter. In order to facilitate acceptance of the rewards program with Burn Partners it is important that any hardware and software used by a Burn Partner in connection with the Rewards Program be easily connected to any existing point of sale system that might be currently employed by potential Burn Partners so that little or no change is required to adopt the Rewards Program. Thus, the embodiments described herein include accommodation of two scenarios.

In one scenario, where the point of sale system is compatible with reading the identification cards, retrieving the available discount for the current sale, and setting the unit price with a discount at the fuel dispenser, the fueling station's back-office servers 152 can interface with database servers 124 directly. In this scenario, an example of which is illustrated in FIG. 4, a Program Member would first be prompted to swipe his/her bank card through the CRIND 140 to set up a sale. The Program Member would then be prompted to swipe his/her identification card through the CRIND. Once the identification card has been swiped, the identification information is transferred through the network of the point of sale system to the back office server 156. Once prompted that the sale at the particular pump is one in which a discounted sale can apply if any discounts are available, the back-office server can then forward a discount information request to the database server over the network (message MD. The request includes the data identifying the Program Member so that his/her account can then be checked to determine whether he/she is eligible for a discount, and if so how much. The appropriate discount data is then transmitted back to the back-office server 156, and subsequently transmitted through the point of sale network to the appropriate pump (message M2). The appropriate discount is communicated to the pump controller which functions to set the unit price of the fuel. The unit price is then set to reflect the discount. For example, if the current unit price of fuel at the particular pump is set to for $3.00/gallon, and the discount provided from the server 124 is $0.20/gallon, the per unit price will be reset to $2.80/gallon. Once the sale is completed, the back-office server will then report a reward burn to the database servers 124 (message M3), so that the Program Member's account will show that a certain reward(s) has been burned, and the identity of the Bum Partner for subsequent accounting purposes.

In a second scenario the point of sale system can not be easily modified to adopt the rewards program interface. In this case an intercepting device 160 can communicate directly between the pump controller and the with the database servers 124. The point of sale system would prompt the person at the pump for his/her rewards identification card first. The point of sale system would not recognize this card, but the intercepting device 160 would. The intercepting device is designed to insure that the point of sales system remains idle during this time (as though no card had been swiped). The user would then swipe his/her bank card. The intercepting device 160 would communicate the identification information to the database servers 124 so as to retrieve the discount data (message M1 in FIG. 4). The discount data is then transmitted back to the device 160 (message M2 in FIG. 4). Device 160 is connected directly to the pump controller so that the unit price of fuel can be adjusted to reflect the discounted amount. Once the sale is completed, payment is processed by the point of sale system in the usual manner, and the sale will reflect the discount. The intercepting device 160 then receives an indication that the sale is completed, and will transmit data back to the database servers indication that the specific rewards have been burned and the identity of the Burn Partner for subsequent accounting purposes (message M3 in FIG. 4).

In one embodiment, the database servers 124 can include two types of databases, a members database and an on-line database. These databases can be stored on separate computer servers, the same server, or otherwise. The database servers comprise storage media for storing the data that makes up each database, and allows for the various transactions described hereinafter. As shown in FIG. 2, each member is provided with a member database entry 200 in the member database corresponding to a reward program membership. The member is assigned an internal identification number 204, which identifies the member within the member database. When a person joins an earn partner's reward program, he or she is typically issued a card in accordance with the earn partner's program. Each time the consumer earns (or is issued) a reward, the reward information the information is processed by the Earn Partner's server 116 or 120. The server then sends data to the member database, including the reward information (including the nature and amount of the reward and any limitations of the redemption of the rewards, such as expiration of the particular reward), the member's internal identification number, and identification information identifying the Earn Partner who has issued the reward. If it does not previously exist, a record 200 is established for the Program Member in the member database, and appropriate fields in various tables of the database are populated with Program Member's data, including the data received from the initial and any subsequent Earn Partner's server.

For each Earn Partner, an itemized list of earned rewards 212 received from the corresponding earn partner can be stored in the members database. Similarly, as each reward is burned at a Burn Partner's facility, an itemized list of the burn adjustments 216 used by the consumer can also be accounted for in the members database. The data relating to the burn adjustments 216 include the specific reward that was burned, and an identification of the Burn Partner. If a Program Member belongs to two or more Earn Partner reward programs, and the Program Member has not linked the accounts, then the Program member will need to use the individual Earn Partner identification card to identify the which rewards the Earn Partner wants to redeem. Once identified, and the reward is redeemed, the data transferred from the Burn Partner will be entered into the Program Member's account as a specific redemption of that reward associated with the original Earn Partner.

In accordance with one embodiment, FIG. 2 demonstrates that a Program Member may link his or her member accounts 224 corresponding to multiple reward program memberships to which the Program Member subscribes. For example, a Program Member can access a website on an interface server 128 via the Internet to link these accounts. Such a website can prompt a Program Member to log-in, identify the programs of which the Program Member is a member, and request that the Program Member select which of those programs are to be linked for joint burning of earned rewards. As shown in the FIG. 3, the Program Member can link his/her memberships in the programs of Store 1 (208), Store 2 (228), and Store 3 (232). Once linked per such user activation, the linked member accounts in the database can be referenced by a single internal identification number 236 so that rewards earned and burned in each program are combined (or stacked) and thereby cumulatively applied. Further, when rewards are burned, they can be partially and proportionately deducted from each linked Earn Partner account if the available rewards are not completely used. Linking of accounts can be accomplished a number of other ways, including over a network such as the internet, as well as through a customer service representative.

In one embodiment, the database servers 124 can also include an on-line database which can be accessed by the Program Member. This on-line database would include only a listing of available rewards to the Program Member, and any restrictions on the redemption of those rewards, allowing the Program Member easy access to the information. FIG. 3 shows by way of example, on-line database entries 300, 304 for linked and non-linked accounts. The linked on-line database entry 300 includes data on the earn partners 208, 228, 232, a Program Member's identification number 308 corresponding to those Earn Partners' programs in whose programs the customer participates, and the sum total amount 312 of the discount awards available to the Program Member. The accounts can also be unlinked 200, 304, wherein each account only includes rewards earned and burned with the corresponding Earned Partner as a part of its Award Program, instead of combining earning and burning of rewards. Because the on-line database has a pre-calculated total available discount value for each Program Member, this database can provide fast response times and quick access to available discounts when such discount entitlements are requested by fueling stations for burn requests. And the Program Member can access his/her account through the internet to determine the status of his/her account.

As noted above, each Program Member can have one or more cards for membership in programs of multiple Earn Partners in which the Program Member participates. These cards can offer a number of ways of providing customer identification, including bar codes and magnetic strips. The Program Member can also be identified in other ways, such as biometrics, and with a unique transponder given to the Program member (e.g., a wireless transponder). At the fueling stations, a consumer may use the loyalty card or other identification from any linked programs in which the consumer participates or another card which can provide the consumers internal identification number 204, 236. Additional data, such as a personal identification number, can be requested from the consumer for authentication and security checks.

The Program Administrator can facilitate settlement between the Earn Partners and the Burn Partners with respect to each transaction by providing suitable accounting between the two groups. For example, once an earned reward is redeemed, the Program Manager can provide an accounting to both the associated Earn Partner(s) and the Burn Partner, insuring that the appropriate Earn Partners pay for the rewards redeemed, and the appropriate Burn Partner is paid for redeeming the appropriate rewards. This accounting can be done any number of ways including providing an accounting to the Earn and Burn Partners involved with each transaction after each transaction has occurred, or the Program Manager can simply accumulate the amount redeemed through its server databases 124, and provide a periodic accounting to all of the Earn and Burn Partners using for example batch processing techniques.

It should be appreciated that the disclosure has been particularly shown and described with references to preferred embodiments thereof. It will be understood by those skilled in the art that various changes in form and details may be made therein without departing from the spirit and scope of what the applicants believe to be novel aspects of the disclosure.

What is claimed is:

1. A reward program management system for managing a combination of a plurality of rewards earned by a person through participation in a plurality of reward earning programs of different earn partners, the person having a plurality of identifiers associated with the person, at least some of which being in respect of the plurality of reward earning programs, the system comprising:
at least one server accessible to earn partners via electronic communication over at least one network, the at least one server configured to receive reward information from earn partners, the reward information including, in respect of the person, at least a reward earned by the person and one of the plurality of identifiers associated with the person associated with the reward;
at least one computer-readable information storage medium in electronic communication with the at least one server, the at least one computer-readable information storage medium including at least one database storing at least a plurality of the rewards earned by the person and the identifier associated with each reward;
the at least one server accessible to the person via the at least one network and in electronic communication with the at least one computer-readable information storage medium, the at least one server configured to provide the person with an interface to receive information from the person regarding at least two of the plurality of identifiers associated with the person to create a set of linked identifiers associated with the person;
a computer processor in electronic communication with the at least one computer-readable information storage medium, for retrieving and totaling the rewards earned by the person stored in the at least one database in association with all of the identifiers of the set of linked identifiers, to create a total reward associated with the person, the at least one database storing at least the total reward associated with the person and at least one of the set of linked identifiers; and
the at least one server accessible to burn partners via the at least one network and in electronic communication with at least one computer-readable information storage medium, the at least one server configured to provide information regarding the total reward associated with the person upon receipt from a burn partner of the at least one of the set of linked identifiers.

2. A reward program management system for managing a combination of a plurality of rewards earned by a person through participation in a plurality of reward earning programs of different earn partners, the person having a plurality of identifiers associated with the person, at least some of which being in respect of the plurality of reward earning programs, the system comprising:
a first server accessible to earn partners via electronic communication over a first network, the first server configured to receive reward information from earn partners, the reward information including, in respect of the person, at least a reward earned by the person and one of the plurality of identifiers associated with the person associated with the reward; a first computer-readable information storage medium in electronic communication with the first server, the first computer-readable information storage medium including a first database storing at least a plurality of the rewards earned by the person and the identifier associated with each reward;
a second server accessible to the person via a second network and in electronic communication with the first computer-readable information storage medium, the first server configured to provide the person with an interface to receive information from the person regarding at least two of the plurality of identifiers associated with the person to create a set of linked identifiers associated with the person;
a computer processor in electronic communication with the first computer-readable information storage medium, for retrieving and totaling the rewards earned by the person stored in the first database in association with all of the identifiers of the set of linked identifiers, to create a total reward associated with the person;
a second computer-readable information storage medium in electronic communication with the computer processor, the second computer-readable information storage medium including a second database storing at least the total reward associated with the person and at least one of the set of linked identifiers; and
a third server accessible to burn partners via a third network and in electronic communication with the second computer-readable information storage medium, the third server configured to provide information regarding the total reward associated with the person upon receipt from a burn partner of the at least one of the set of linked identifiers.

3. A reward program management system as recited in claim 1, further comprising:
a first earn partner computer system, including:
a first input device for inputting a first one of the set of linked identifiers associated with the person, and
a second computer processor analyzing a first transaction conducted by the person with a first earn partner and generating information about a first reward earned by the person in respect of the first transaction, the second computer processor being in electronic communication with the first input device and via the first network with the first computer-readable information storage medium to send information regarding the first reward earned by the person in respect of the first transaction and the first one of the set of linked identifiers associated with the person to the first computer-readable information storage medium;
a second earn computer system, including:
a second input device for inputting a second one of the set of linked identifiers associated with the person, and
a third computer processor analyzing a second transaction conducted by the person with a second earn partner and generating information about a second reward earned by the person in respect of the second transaction, the third computer processor being in electronic communication with the second input device and via the first network with the first computer-readable information storage medium to send information regarding the second reward earned by the person in respect of the second transaction and the second one of the set of linked identifiers associated with the person to the first computer-readable information storage medium.

4. A reward program management system as recited in claim 3, wherein the first reward, the second reward, and the total reward are each a reduction in a predetermined per unit price of fuel.

5. A reward program management system as recited in claim 4, further comprising:
a fuel pump for pumping fuel into a vehicle at the predetermined price per unit of fuel;
a third input device for inputting one of the set of linked identifiers associated with the person in electronic communication with the fuel pump; and
a fuel controller in electronic communication with the fuel pump for controlling the pumping of fuel by the pump and in electronic communication with the second information storage medium to receive the information regarding the total reward associated with the person upon one of the set of linked identifiers having been input by the person via the third input device, the fuel controller being configured to reduce the predetermined price per unit of fuel by at least the total reward associated with the person.

6. A reward program management system as recited in claim 5, wherein
the plurality of identifiers associated with the person includes a master identifier associated with the person,
the interface that the second server is configured to provide is configured to receive information from the person regarding the master identifier to include the master identifier in the set of linked identifiers associated with the person,
the at least one of the set of linked identifiers stored in the second database is solely the master identifier, and
the third server is configured to provide information regarding the total reward associated with the person solely upon receipt from the burn partner of the master identifier.

7. A reward program management system as recited in claim 6, wherein the master identifier is distinct from those identifiers of the plurality of identifiers associated with the person that are in respect of the plurality of reward earning programs.

8. A reward program management system as recited in claim 4, further comprising:
a fuel pump for pumping fuel into a vehicle at the predetermined price per unit of fuel;
a third input device for inputting one of the set of linked identifiers associated with the person in electronic communication with the fuel pump;
a fuel controller in electronic communication with the fuel pump for controlling the pumping of fuel by the pump; and
a burn partner point of sale system in electronic communication with the fuel controller and in electronic communication with the second information storage medium to receive the information regarding the total reward associated with the person upon one of the set of linked identifiers having been input by the person via the third input device, the burn partner point of sale system being configured to cause the reduction of the predetermined price per unit of fuel by at least the total reward associated with the person.

9. A reward program management system as recited in claim 8, wherein
the plurality of identifiers associated with the person includes a master identifier associated with the person,
the interface that the second server is configured to provide is configured to receive information from the person regarding the master identifier to include the master identifier in the set of linked identifiers associated with the person,
the at least one of the set of linked identifiers stored in the second database is solely the master identifier, and
the third server is configured to provide information regarding the total reward associated with the person solely upon receipt from the burn partner of the master identifier.

10. A reward program management system as recited in claim 9, wherein the master identifier is distinct from those identifiers of the plurality of identifiers associated with the person that are in respect of the plurality of reward earning programs.

11. A reward program management system as recited in claim 4, further comprising:
a fuel pump for pumping fuel into a vehicle at the predetermined price per unit of fuel;
a third input device for inputting one of the set of linked identifiers associated with the person in electronic communication with the fuel pump;
a fuel controller in electronic communication with the fuel pump for controlling the pumping of fuel by the pump; and
an electronic fuel price reduction device in electronic communication with the fuel pump for reducing the predetermined unit price set via the fuel controller, and in electronic communication with the second information storage medium to receive the information regarding the total reward associated with the person upon one of the set of linked identifiers having been input by the person via the third input device, the electronic fuel price reduction device being configured to reduce the predetermined price per unit of fuel by at least the total reward associated with the person.

12. A reward program management system as recited in claim 11, wherein
the plurality of identifiers associated with the person includes a master identifier associated with the person,
the interface that the second server is configured to provide is configured to receive information from the person regarding the master identifier to include the master identifier in the set of linked identifiers associated with the person,
the at least one of the set of linked identifiers stored in the second database is solely the master identifier, and
the third server is configured to provide information regarding the total reward associated with the person solely upon receipt from the burn partner of the master identifier.

13. A reward program management system as recited in claim 12, wherein the master identifier is distinct from those identifiers of the plurality of identifiers associated with the person that are in respect of the plurality of reward earning programs.

14. A reward program management system as recited in claim 4, further comprising:
a fuel pump for pumping fuel into a vehicle at a predetermined price per unit of fuel;
a fuel controller in electronic communication with the fuel pump for controlling the pumping of fuel by the pump;
a burn partner point of sale system, the burn partner point of sale system including a third input device for inputting one of the set of linked identifiers associated with the person, the burn partner point of sale system being in electronic communication with the fuel controller and being in electronic communication with the second information storage medium to receive the information regarding the total reward associated with the person upon one of the set of linked identifiers having been input by the person via the third input device, the burn partner point of sale system being configured to cause the reduction of the predetermined price per unit of fuel by at least the total reward associated with the person.

15. A reward program management system as recited in claim 14, wherein
the plurality of identifiers associated with the person includes a master identifier associated with the person,
the interface that the second server is configured to provide is configured to receive information from the person regarding the master identifier to include the master identifier in the set of linked identifiers associated with the person,
the at least one of the set of linked identifiers stored in the second database is solely the master identifier, and
the third server is configured to provide information regarding the total reward associated with the person solely upon receipt from the burn partner of the master identifier.

16. A reward program management system as recited in claim 15, wherein the master identifier is distinct from those identifiers of the plurality of identifiers associated with the person that are in respect of the plurality of reward earning programs.

17. A reward program management system as recited in claim 4, further comprising:
a fuel pump for pumping fuel into a vehicle at a predetermined price per unit of fuel;
a fuel controller in electronic communication with the fuel pump for controlling the pumping of fuel by the pump;
a burn partner point of sale system in electronic communication with the fuel controller;
a third input device for inputting one of the set of linked identifiers associated with the person, the third input device being in electronic communication with the second information storage medium to receive the information regarding the total reward associated with the person upon one of the set of linked identifiers having been input by the person, the third input device in communication with the burn partner point of sale system to cause the reduction of the predetermined price per unit of fuel by at least the total reward associated with the person.

18. A reward program management system as recited in claim 17, wherein
the plurality of identifiers associated with the person includes a master identifier associated with the person,
the interface that the second server is configured to provide is configured to receive information from the person regarding the master identifier to include the master identifier in the set of linked identifiers associated with the person,
the at least one of the set of linked identifiers stored in the second database is solely the master identifier, and
the third server is configured to provide information regarding the total reward associated with the person solely upon receipt from the burn partner of the master identifier.

19. A reward program management system as recited in claim 18, wherein the master identifier is distinct from those identifiers of the plurality of identifiers associated with the person that are in respect of the plurality of reward earning programs.

20. A reward program management system as recited in claim 3, wherein the first earn partner is a grocer and the second earn partner is other than a grocer.

21. A reward program management system as recited in claim 2, wherein the first network, the second network, and the third network are each the Internet.

22. A reward program management system as recited in claim 1,
wherein the total reward is a reduction in a predetermined per unit price of fuel at the burn partner; and
further comprising:
a fuel pump for pumping fuel into a vehicle at the predetermined price per unit of fuel, the fuel pump including a first input device for inputting one of the set of linked identifiers associated with the person; and
a fuel controller in electronic communication with the fuel pump for controlling the pumping of fuel by the pump and in electronic communication with the second information storage medium to receive the information regarding the total reward associated with the person upon one of the set of linked identifiers having been input by the person via the first input device, the fuel controller being configured to reduce the predetermined price per unit of fuel by the total reward associated with the person.

23. A reward program management system as recited in claim 22, wherein
the person has a master identifier distinct from those identifiers of the plurality of identifiers associated with the person that are in respect of the plurality of reward earning programs,
the interface that the at least one server is configured to provide is configured to receive information from the person regarding the master identifier to include the master identifier in the set of linked identifiers associated with the person,
the at least one server is configured to provide information regarding the total reward associated with the person solely upon receipt from the burn partner of the master identifier.

24. A reward program management system as recited in claim 1,
wherein the total reward is a reduction in a predetermined per unit price of fuel at a burn partner; and
further comprising:
a fuel pump for pumping fuel into a vehicle at the predetermined price per unit of fuel, the fuel pump including a first input device for inputting one of the set of linked identifiers associated with the person; and
a fuel controller in electronic communication with the fuel pump for controlling the pumping of fuel by the pump;
a burn partner point of sale system in electronic communication with the fuel controller and in electronic communication with the second information storage medium to receive the information regarding the total reward associated with the person upon one of the set of linked identifiers having been input by the person via the first input device, the burn partner point of sale system being configured to cause the reduction of the predetermined price per unit of fuel by the total reward associated with the person.

25. A reward program management system as recited in claim 24, wherein
the person has a master identifier distinct from those identifiers of the plurality of identifiers associated with the person that are in respect of the plurality of reward earning programs,
the interface that the at least one server is configured to provide is configured to receive information from the person regarding the master identifier to include the master identifier in the set of linked identifiers associated with the person,
the at least one server is configured to provide information regarding the total reward associated with the person solely upon receipt from the burn partner of the master identifier.

26. A reward program management system as recited in claim 1,
wherein the total reward is a reduction in a predetermined per unit price of fuel at a burn partner; and
further comprising:
a fuel pump for pumping fuel into a vehicle at the predetermined price per unit of fuel, the fuel pump including a first input device for inputting one of the set of linked identifiers associated with the person;
a fuel controller in electronic communication with the fuel pump for controlling the pumping of fuel by the pump;
an electronic fuel price reduction device in electronic communication with the fuel pump for reducing the predetermined unit price set via the fuel controller, and in electronic communication with the second information storage medium to receive the information regarding the total reward associated with the person upon one of the set of linked identifiers having been input by the person via the first input device, the electronic fuel price reduction device being configured to reduce the predetermined price per unit of fuel by the total reward associated with the person.

27. A reward program management system as recited in claim 26, wherein
the person has a master identifier distinct from those identifiers of the plurality of identifiers associated with the person that are in respect of the plurality of reward earning programs,
the interface that the at least one server is configured to provide is configured to receive information from the person regarding the master identifier to include the master identifier in the set of linked identifiers associated with the person,
the at least one server is configured to provide information regarding the total reward associated with the person solely upon receipt from the burn partner of the master identifier.

28. A reward program management system as recited in claim 1,
wherein the total reward is a reduction in a predetermined per unit price of fuel at a burn partner; and
further comprising:
a fuel pump for pumping fuel into a vehicle at the predetermined price per unit of fuel;
a fuel controller in electronic communication with the fuel pump for controlling the pumping of fuel by the pump;
a burn partner point of sale system, the burn partner point of sale system including a first input device for inputting one of the set of linked identifiers associated with the person, the burn partner point of sale system being in electronic communication with the fuel controller and being in electronic communication with the second information storage medium to receive the information regarding the total reward associated with the person upon one of the set of linked identifiers having been input by the person via the first input device, the burn partner point of sale system being configured to cause the reduction of the predetermined price per unit of fuel by the total reward associated with the person.

29. A reward program management system as recited in claim 28, wherein
the person has a master identifier distinct from those identifiers of the plurality of identifiers associated with the person that are in respect of the plurality of reward earning programs,
the interface that the at least one server is configured to provide is configured to receive information from the person regarding the master identifier to include the master identifier in the set of linked identifiers associated with the person,
the at least one server is configured to provide information regarding the total reward associated with the person solely upon receipt from the burn partner of the master identifier.

30. A reward program management system as recited in claim 1,
wherein the total reward is a reduction in a predetermined per unit price of fuel at a burn partner; and
further comprising:
a fuel pump for pumping fuel into a vehicle at the predetermined price per unit of fuel;
a fuel controller in electronic communication with the fuel pump for controlling the pumping of fuel by the pump;
a burn partner point of sale system in electronic communication with the fuel controller;
a first input device for inputting one of the set of linked identifiers associated with the person, the first input device being in electronic communication with the at least one information storage medium to receive the information regarding the total reward associated with the person upon one of the set of linked identifiers having been input by the person, the first input device in communication with the burn partner point of sale system to cause the reduction of the predetermined price per unit of fuel by at least the total reward associated with the person.

31. A reward program management system as recited in claim 30, wherein
the person has a master identifier distinct from those identifiers of the plurality of identifiers associated with the person that are in respect of the plurality of reward earning programs,
the interface that the at least one server is configured to provide is configured to receive information from the person regarding the master identifier to include the master identifier in the set of linked identifiers associated with the person,
the at least one server is configured to provide information regarding the total reward associated with the person solely upon receipt from the burn partner of the master identifier.

32. A method of managing a plurality of reward earning programs in order to provide for joint burning of rewards earned through different ones of the plurality of reward earning programs, comprising:
receiving, via at least one network, a first electronic signal representative of information including at least (i) a first reward earned by the person at a first earn partner through a first reward earning program, and (ii) a first identifier associated with the person in respect of the first reward;
storing the information received via the first electronic signal in at least one computer-readable information storage medium;
receiving, via the at least one network, a second electronic signal representative of information including at least (ii) a second reward earned by the person at a second earn partner through a second earning program, and (ii) a second identifier associated with the person in respect of the second reward;
storing the information received via the second electronic signal in the at least one computer-readable information storage medium;
sending, via the at least one network, a third electronic signal representative of an interface allowing the person input at least the first identifier and the second identifier;
receiving, via the at least one network, a fourth electronic signal representative of at least the first identifier and the second identifier generated in response to input from the person;
creating a link, via at least one computer processor, between at least the first identifier and the second identifier to create a set of linked identifiers associated with the person; totaling, via the at least one computer processor, the rewards earned by the person stored in association with all the identifiers of the set of linked identifiers to create a total reward associated with the person;
receiving, via the at least one network, a fifth electronic signal representative of the at least one of the set of linked identifiers associated with the person;
sending, via the at least one network, a sixth electronic signal representative of the total reward associated with the person.

33. A method of managing a plurality of reward earning programs as recited in claim 32, further comprising storing the total reward associated with the person and at least one of the set of linked identifiers in the at least one computer-readable storage medium.

34. A method of managing a plurality of reward earning programs in order to provide for joint burning of rewards earned through different ones of the plurality of reward earning programs, comprising:
receiving, via a first network, a first electronic signal representative of information including at least (i) a first reward earned by the person at a first earn partner through a first reward earning program, and (ii) a first identifier associated with the person in respect of the first reward;
storing the information received via the first electronic signal in a first computer-readable information storage medium;
receiving, via the first network, a second electronic signal representative of information including at least (ii) a second reward earned by the person at a second earn partner through a second earning program, and (ii) a second identifier associated with the person in respect of the second reward;
storing the information received via the second electronic signal in the first computer-readable information storage medium;
sending, via a second network, a third electronic signal representative of an interface allowing the person input at least the first identifier and the second identifier;
receiving, via the second network, a fourth electronic signal representative of at least the first identifier and the second identifier generated in response to input from the person;
creating a link, via a first computer processor, between at least the first identifier and the second identifier to create a set of linked identifiers associated with the person; totaling, via a second computer processor, the rewards earned by the person stored in association with all the identifiers of the set of linked identifiers to create a total reward associated with the person;
receiving, via a third network, a fifth electronic signal representative of the at least one of the set of linked identifiers associated with the person;
sending, via the third network, a sixth electronic signal representative of the total reward associated with the person.

35. A method of managing a plurality of reward earning programs as recited in claim 34, further comprising storing the total reward associated with the person and at least one of the set of linked identifiers in a second computer-readable storage medium;

36. A method of managing a plurality of reward earning programs as recited in claim 34, further comprising:
prior to receiving the first electronic signal, via a third computer processor,
receiving input representative of the first identifier,
determining that the person has conducted a first reward earning transaction with the first earn partner,
sending the first electronic signal; and
prior to receiving the second electronic signal, via a fourth computer processor,
receiving input representative of the second identifier,
determining that the person has conducted a second reward earning transaction with the second earn partner,
sending the second electronic signal.

37. A method of managing a plurality of reward earning programs as recited in claim 36,
wherein the first reward, the second reward, and the total reward are each a reduction in a predetermined per unit price of fuel; and
further comprising, after sending the sixth electronic signal, via a fifth computer processor:
reducing the predetermined per unit price of fuel by at least the total reward associated with the person; and
pumping fuel at the reduced price per unit.

38. A method of managing a plurality of reward earning programs as recited in claim 34,
wherein the first reward, the second reward, and the total reward are each a reduction in a predetermined per unit price of fuel; and
further comprising, after sending the sixth electronic signal, via a third computer processor:
reducing the predetermined per unit price of fuel by at least the total reward associated with the person; and
pumping fuel at the reduced price per unit.

39. A method of managing a plurality of reward earning programs in order to provide for joint burning of rewards earned through different ones of the plurality of reward earning programs, comprising:
receiving, via a first network, a first electronic signal representative of information including at least (i) a first reward earned by the person at a first earn partner through a first reward earning program, and (ii) a first identifier associated with the person in respect of the first reward;
storing the information received via the first electronic signal in a first computer-readable information storage medium;
receiving, via the first network, a second electronic signal representative of information including at least (ii) a second reward earned by the person at a second earn partner through a second earning program, and (ii) a second identifier associated with the person in respect of the second reward;
storing the information received via the second electronic signal in the first computer-readable information storage medium;
sending, via a second network, a third electronic signal representative of an interface allowing the person input at least the first identifier, the second identifier, and a master identifier;
receiving, via the second network, a fourth electronic signal representative of at least the first identifier, the second identifier, and the master identifier generated in response to input from the person;
creating a link, via a first computer processor, between at least the first identifier, the second identifier, and the master identifier to create a set of linked identifiers associated with the person;
totaling, via a second computer processor, the rewards earned by the person stored in association with all the identifiers of the set of linked identifiers to create a total reward associated with the person;
receiving, via a third network, a fifth electronic signal representative of the master identifier associated with the person;
sending, via the third network, a sixth electronic signal representative of the total reward associated with the person.

40. A method of managing a plurality of reward earning programs as recited in claim 40, further comprising storing the total reward associated with the person and the master identifier in a second computer-readable storage medium.

41. A method of managing a plurality of reward earning programs as recited in claim 41, wherein the master identifier is distinct from the first identifier and the second identifier.

42. A method of managing a plurality of reward earning programs as recited in claim 42, wherein the first reward, the second reward, and the total reward are each a reduction in a predetermined per unit price of fuel; and
further comprising, after sending the sixth electronic signal, via a third computer processor:
reducing the predetermined per unit price of fuel by at least the total reward associated with the person; and
pumping fuel at the reduced price per unit.

43. A reward program management system comprising:
a plurality of rewards earned by a person through participation in a plurality of reward earning programs of different earn partners, the person having a plurality of identifiers associated with the person in respect of the plurality of reward earning programs, each of the rewards having at least one of the plurality of identifiers associated therewith, at least two of the rewards having different ones of the plurality of identifiers associated therewith;
a master identifier associated with the person; and
an interface allowing the person to link the plurality of identifiers with the master identifier so as to permit joint burning of the plurality of rewards.

44. A reward program management system as recited in claim 44, wherein each of the plurality of rewards is a reduction in a predetermined per unit price of fuel.

45. A reward program management system as recited in claim 45, further comprising:
a fuel pump for pumping fuel into a vehicle at the predetermined price per unit of fuel;
a fuel pump control system in electronic communication with the fuel pump for controlling the pumping of fuel by the pump and configured to reduce the predetermined price per unit of fuel by at least a total of the plurality of rewards.

46. A reward program management system as recited in claim 45, wherein the master identifier is distinct from the plurality of identifiers associated with the person in respect of the plurality of reward earning programs.

47. A method of managing a plurality of reward earning programs in order to provide for joint burning of rewards earned through different ones of the plurality of reward earning programs, comprising:
receiving first reward information including at least (i) a first reward earned by the person at a first earn partner through a first reward earning program, and (ii) a first identifier associated with the person in respect of the first reward;
receiving second reward information including at least (ii) a second reward earned by the person at a second earn partner through a second earning program, and (ii) a second identifier associated with the person in respect of the second reward;
linking the first identifier and the second identifier to create a set of linked identifiers associated with the person;
totaling the rewards earned by the person stored in association with all the identifiers of the set of linked identifiers to create a total reward associated with the person;
sending the total reward associated with the person for burning.

48. A method of managing a plurality of reward earning programs as recited in claim 48, wherein the first reward, the second reward, and the total reward are each a reduction in a predetermined per unit price of fuel.

49. A method of managing a plurality of reward earning programs as recited in claim 48, wherein the set of linked identifiers includes a master identifier distinct from the first identifier and the second identifier.

50. A software interface permitting a person to maintain one or more reward program memberships, the interface being configured to provide displays including:
a prompt requesting identification information;
a list of earn partner rewards programs in which a person participates;
information on earned rewards for each earn partner on the list; and
an option to link two or more of the earn partner rewards programs on the list to jointly burn rewards earned in linked earn partner rewards programs.

51. A website including one or more storage media for storing instructions and data for carrying out various steps associated with one or more rewards programs including:
creating one or more member accounts associated with one or more rewards programs, respectively, of which a person is a member;
linking two or more existing member accounts;
accessing the customer accounts using one form of identification; and
accounting for earned rewards accrued from rewards earned in the two or more rewards programs and burned rewards burned by the person.
